(19) United States
(12) Patent Application Publication
(10) Pub. No.: US 2007/0047258 A1
(43) Pub. Date: Mar. 1, 2007

(54) Light guide plate having two micro structures and back light unit having the light guide plate

(75) Inventors: Po-Hung Yao, Hsinchu Hsien (TW); Yu-Nan Pao, Hsinchu (TW); Yi-Ting Sun, Hsinchu (TW); Ben-Sheng Lin, Hsinchu (TW); Tsung-Hsin Lin, Hsinchu (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/408,079

(22) Filed: Apr. 21, 2006

(30) Foreign Application Priority Data
Aug. 30, 2005 (TW) 094129633

(51) Int. Cl. F21V 7/04

(52) U.S. Cl. 362/615

(57) ABSTRACT

A light guide plate is provided. The light guide plate has a transparent substrate having a first optical face and a second optical face, a first micro structure and a second micro structure respectively corresponding to the first optical face and the second optical face. The first micro structure has a tunable composite optical effect with light collection and diffusion functions so as to increase brightness and evenness of exit light. The second micro structure has a design of curved face to destroy total reflection of light, such that bright lines can be effectively prevented from occurrence by avoiding the light outputting from the direction over against the first optical face. A back light unit having the light guide plate is further provided in the present invention.

### BACKGROUND OF THE INVENTION

1. Field of the Invention

The present invention relates to an optical modulation technique and, more particularly to a light guide plate having two micro structures and a back light unit having the light guide plate.

2. Descriptions of Related Arts

Recently, digital products in new generation not only can integrate technique of information, consumption and communication fields, but also has good multimedia performance with the rapid development of related technical fields. Moreover, an image processing technique has become a notable development art with maturation of accessory art and application increment. Thus, demands of various digital products having display function especially LCD are becoming more and more important. According to the estimate of Display Search, the amounts of future LCD TV will reach to 16240 thousand in 2006 at high requests; thereby another business in critical accessories of LCD will come forth, wherein the development of back light units is a most important project.

As LCD is not a self-luminous panel display, a critical accessory—the back light unit as is mentioned above must be used for providing back light source. For example, cost of a back light unit in a 15-inch TFT-LCD is second only to that of a color filter, so research for reducing the cost of the back light unit has constantly been performed in display industry. Certainly, with disparate development of digital products, back light units are widely used in information, communication and consumption products besides LCD, such as mobile phones, digital cameras, PDA, palm electrical toys and the like.

In the present back light unit, critical accessories comprising a light guide plate and optical films such as diffuser, BEF (Brightness Enhancement Film) or DBEF (Dual BEF) are used to guide light, uniform light and concentrate light; wherein the light guide plate is the most important factor affecting the quality of back light unit with small size.

Microdots or V-shaped grooves are made on a bottom face or dual faces of the light guide plate to guide light and uniform light in present structure design of the light guide plate. Generally, the light guide plate having V-shaped grooves has stronger brightness than the light guide plate having microdots at the same light source, but if V-shaped grooves are on both faces of the light guide plate, bright lines which cause unevenness exit light may be formed easily on the surface of the light guide plate.

Discussing formation reason of the bright lines, it can be inferred from Snell's Law in optics that total reflection may occur on a side face of the V-shaped grooves after the light source inputs into a side face of the light guide plate, and much light may output over against upside of the V-shaped grooves to cause bright lines of the light guide plate. Accordingly, related techniques for reducing bright lines are proposed as disclosed in U.S. Pat. No. 6,568,822 B2, U.S. Pat. No. 6,139,163 and U.S. Pat. No. 6,851,815 B2.

Referring to FIG. 1A and FIG. 1B, a plurality of micro structures are proposed in U.S. Pat. No. 6,568,822 B2, which diffuse input light and evenly illuminate a target so as to avoid bright lines. A light guide plate 1 having a notch 11 and prisms 13 is shown in FIG. 1A. The curvature and the size of the notch 11 is specially designed, such that prisms 13 can be attached or otherwise provided on the output edge or surface to further redirect light towards the target 15 after the light source 17 input through the notch 11 to diffuse the exit angle. Additionally, another micro structure 19 having an aspheric arc-shaped face which formed at the exit of the light source is proposed in FIG. 1B, and relationship between the size of the micro structure 19 and distribution of exit light is discussed therein.

However, as the design of the notch 11 or the micro structure 19 mentioned in U.S. Pat. No. 6,568,822 B2 is an aspheric curvature, it is hard in fabrication. Accordingly, such technique not only is useless to industry value, but also has high cost for its hard fabrication.

Moreover, it proposed a technique of inputting light inside the light guide plate after constantly reflection and refraction in U.S. Pat. No. 6,139,163. As shown in FIG. 2, a semicircular cylindrical groove 23 and a triangular hole 25 are made on the light guide plate 2 in the front of a light source 21, and a plurality of semicircular cylindrical grooves 27 are also made at the edge of the light guide plate. Large angles of light distribution may be formed by use of constantly reflection and refraction-of the light, and then the light inputs inside the light guide plate 2, such that even exit light can be attained.

However, great loss of energy may be caused to reduce energy of the exit light in the above U.S. Pat. No. 6,139,163 as much reflection and refraction of the light must be performed before inputting the light inside the light guide plate. Furthermore, it is hard in practical fabrication because the structure is complicated and economic effect still can not be estimated.

In addition, micro structures made on two faces of the light guide plate are proposed in U.S. Pat. No. 6,851,815 B2, pyramid-shaped micro structures are made on a bottom face of the light guide plate and inverted V-shaped grooves are made on a top face of the light guide plate. The pyramid-shaped micro structures are used to uniform exit light on a surface of the light guide plate, and the V-shaped grooves are used to redirect the light in the light guide plate in order to enhance brightness of the exit light on a front face of the light guide plate. Such micro structure on the top surface of the light guide plate has light collection function but has not diffusion function, and the evenness effect of the exit light is still not good.

Therefore, the present subject to be solved in the art is how to overcome above-mentioned problems disclosed in the prior art.

### SUMMARY OF THE INVENTION

To overcome the above-mentioned problems, it is a primary objective of the present invention to provide a light guide plate and a back light unit having the light guide plate to avoid bright lines.

It is another objective of the present invention to provide a light guide plate and a back light unit having the light guide plate which have a tunable composite optical effect with light collection and diffusion functions so as to increase brightness and evenness of exit light.

To achieve the above-mentioned and other objectives, a light guide plate and a back light unit having the light guide plate are proposed in the present invention. The light guide plate has a transparent substrate having a first optical face and a second optical face opposed to the first optical face, a first micro structure and a second micro structure. The light guide plate is used in the back light unit.

In one preferred embodiment, the first micro structure is formed on the first optical face and has a plurality of light diffusion portions and light collection portions installed in parallel to each other for respectively diffusing and collecting light, and the second micro structure is formed on the second optical face and has at least a light guide portion composed of an inclined face and a curved face.

More preferably, the light diffusion portions and the light collection portions are interlacedly installed in parallel to each other in equal or unequal proportions. Each of the light diffusion portions has an arc-shaped face selected from a group consisting of a spheric surface and an aspheric surface. The curvature radius of the arc-shaped face ranges between 1 μm and 500 μm. Each of the light collection portions has an inverted V-shaped face. The vertex angle of the inverted V-shaped face ranges between 30 degrees and 140 degrees. The curvature radii of the arc-shaped face of any two spatially adjacent light diffusion portions are not equal, and the vertex angles of the inverted V-shaped face of any two spatially adjacent light collection portions are not equal, either. The first micro structure has a plurality of linearly or curvedly extended light diffusion portions and light collection portions installed in parallel to each other. The curvedly extended light diffusion portion and the light collection portion are parallel and/or perpendicular to the first optical face. The parallel light diffusion portions and the light collection portions bend constantly. The light guide portion of the second micro structure has one selected from a group consisting of a projecting structure projected from the second optical face and an indented structure indented into the second optical face. Furthermore, the second micro structure has a plurality of light guide portions interlacedly installed to each other The thickness of the light guide portions are all equal or not equal, the intervals of any two spatially adjacent light guide portions are all equal or not equal or the light guide portions are spatially arranged to each other in equal or unequal proportions, and the heights of any two spatially adjacent light guide portions are not equal.

In a second embodiment, the first micro structure is formed on the first optical face and has at least a light diffusion and collection composite portion for diffusing and collecting light, and the second micro structure is formed on the second optical face and has at least a light guide portion composed of an inclined face and a curved face.

Each of the diffused and the light collected composite portion has an arc-shaped face selected from a group consisting of a spheric surface or an aspheric surface and an inverted V-shaped face formed on the arc-shaped face. The curvature radius of the arc-shaped face ranges between 1 μm and 500 μm, the vertex angle of the inverted V-shaped face ranges between 30 degrees and 140 degrees. The curvature radii of the arc-shaped face of any two spatially adjacent light diffusion and collection composite portions are not equal, and the vertex angles of the inverted V-shaped face of any two spatially adjacent light diffusion and collection composite portions are not equal, either. The first micro structure has a plurality of light diffusion and collection composite portions installed in parallel to each other, or the first micro structure has at least a linearly or curvedly extended light diffusion and collection composite portion instead. In one embodiment, the first micro structure has a plurality of linearly or curvedly extended light diffusion and collection composite portions parallel to each other The curvedly extended light diffusion and collection composite portion is parallel and/or perpendicular to the first optical face The parallel diffused and the light collected composite portions bend constantly. The light guide portion of the second micro structure has one selected from a group consisting of a projecting structure projected from the second optical face and an indented structure indented into the second optical face. Furthermore, the second micro structure has a plurality of light guide portions interlacedly in parallel to each other. The thickness of the light guide portions are all equal or not equal, the intervals of any two spatially adjacent light guide portions are all equal or not equal or the light guide portions are spatially arranged to each other in equal or unequal proportions, and the heights of any two spatially adjacent light guide portions are not equal.

In a third preferred embodiment, the first micro structure is formed on the first optical face and has a plurality of light diffusion and collection composite portions and light collection portions installed in parallel to each other for diffusing and collecting light, and the second micro structure is formed on the second optical face and has at least a light guide portion composed of an inclined face and a curved face.

The light diffusion and collection composite portions and the light collection portions are spatially parallel to each other in equal or unequal proportions. Each of the light diffusion and collection composite portions has an arc-shaped face selected from a group consisting of a spheric surface or an aspheric surface and a inverted V-shaped face formed on the arc-shaped face, and each of the light collection portions has an inverted V-shaped face. The curvature radius of the arc-shaped face ranges between 1 μm and 500 μm, and the vertex angle of the inverted V-shaped face ranges between 30 degrees and 140 degrees. The curvature radii of the arc-shaped face of any two spatially adjacent light diffusion and collection composite portions are not equal, and the vertex angles of the inverted V-shaped face of any two spatially adjacent light diffusion and collection composite portions or light collection portions are not equal, either. In one embodiment, the first micro structure has a plurality of linearly or curvedly extended light diffusion and collection composite portions and light collection portions parallel to each other. The curvedly extended light diffusion and collection composite portion and the light collection portion are parallel and/or perpendicular to the first optical face. The parallel diffused and the light collected composite portions and light collection portions bend constantly. The light guide portion of the second micro structure has one selected from a group consisting of a projecting structure projected from the second optical face and an indented structure indented into the second optical face. Furthermore, the second micro structure has a plurality of light guide portions interlacedly installed to each other. The thickness of the light guide portions are all equal or not equal, the intervals of any two spatially adjacent light guide portions are all equal or not equal or the light guide portions are spatially arranged to each other in equal or unequal proportions, and the heights of any two spatially adjacent light guide portions are not equal.

In a fourth preferred embodiment, the first micro structure is formed on the first optical face and has a plurality of light diffusion and collection composite portions and light diffusion portions parallel to each other for diffusing and collecting light, and the second micro structure is formed on the second optical face and has at least a light guide portion composed of an inclined face and a curved face.

The light diffusion and collection composite portions and the light diffusion portions are installed in parallel to each other in equal or unequal proportions. Each of the light diffusion and collection composite portions has an arc-shaped face selected from a group consisting of a spheric surface or an aspheric surface and a inverted V-shaped face formed on the arc-shaped face, and each of the light diffusion portions has an arc-shaped face. The curvature radius of the arc-shaped face ranges between 1 μm and 500 μm, the vertex angle of the inverted V-shaped face ranges between 30 degrees and 140 degrees, the curvature radii of the arc-shaped face of any two spatially adjacent light diffusion and collection composite portions or light diffusion portions are not equal, and the vertex angles of the inverted V-shaped face of any two spatially adjacent light diffusion and collection composite portions are not equal, either. In one embodiment, the first micro structure has a plurality of linearly or curvedly extended light diffusion and collection composite portions and light diffusion portions parallel to each other. The curvedly extended light diffusion and collection composite portion and the light diffusion portion are parallel and/or perpendicular to the first optical face. The parallel diffused and the light collected composite portions and light diffusion portions bend constantly. The light guide portion of the second micro structure has one selected from a group consisting of a projecting structure projected from the second optical face and an indented structure indented into the second optical face. Furthermore, the second micro structure has a plurality of light guide portions interlacedly installed to each other. The thickness of the light guide portions are all equal or not equal, the intervals of any two spatially adjacent light guide portions are all equal or not equal or the light guide portions are spatially arranged to each other in equal or unequal proportions, and the heights of any two spatially adjacent light guide portions are not equal.

In a fifth preferred embodiment, the first micro structure is formed on the first optical face and has a plurality of light diffusion portions, light collection portions and light diffusion and collection composite portions parallel to each other for diffusing and collecting light, and the second micro structure is formed on the second optical face and has at least a light guide portion composed of an inclined face and a curved face.

The light diffusion portions, the light collection portions and the light diffusion and collection composite portions are interlacedly in parallel to each other in equal or unequal proportions. Each of the light diffusion and collection composite portions has an arc-shaped face selected from group consisting of a spheric surface or an aspheric surface and an inverted V-shaped face formed on the arc-shaped face. Each of the light diffusion portions has an arc-shaped face, and each of the light collection portions has an inverted V-shaped face. The curvature radius of the arc-shaped face ranges between 1 μm and 500 μm, the vertex angle of the inverted V-shaped face ranges between 30 degrees and 140 degrees. The curvature radii of the arc-shaped face of any two spatially adjacent light diffusion and collection composite portions or light diffusion portions are not equal, and the vertex angles of the inverted V-shaped face of any two spatially adjacent light diffusion and collection composite portions or light collection portions are not equal, either. In one embodiment, the first micro structure has a plurality of linearly or curvedly extended light diffusion portions, light collection portions and light diffusion and collection composite portions parallel to each other. The curvedly extended light diffusion portion, the light collection portion and the light diffusion and collection composite portion are parallel and/or perpendicular to the first optical face. The light diffusion portions, the light collection portions and the light diffusion and collection composite portions bend constantly. The light guide portion of the second micro structure is one of a projecting structure and an indented structure from the second optical face. Furthermore, the second micro structure has a plurality of light guide portions interlacedly installed to each other. The thickness of the light guide portions are all equal or not equal, the intervals of any two spatially adjacent light guide portions are all equal or not equal or the light guide portions are spatially arranged to each other in equal or unequal proportions, and the heights of any two spatially adjacent light guide portions are not equal.

In a sixth preferred embodiment, the first micro structure is formed on the first optical face and has at least a light diffusion and collection composite portion for diffusing and collecting light. A first side of the light diffusion and collection composite portion has an arc-shaped face, and a second side adjacent to the arc-shaped face has an inverted V-shaped face. The second micro structure is formed on the second optical face and has at least a light guide portion composed of an inclined face and a curved face.

The first micro structure has a plurality of light diffusion and collection composite portions arranged in a array. In one embodiment, the first micro structure has a plurality of light diffusion and collection composite portions arranged as a parallel array with at least one curved extension direction. The direction of the curved extension of the light diffusion and collection composite portion is parallel and/or perpendicular to the first optical face. The arc-shaped face and the inverted V-shaped face are perpendicular to each other. The curvature radius of the arc-shaped face range between 1 μm and 500 μm, and the vertex angle of the inverted V-shaped face ranges between 30 degrees and 140 degrees. The light guide portion of the second micro structure has one selected from a group consisting of a projecting structure projected from the second optical face and an indented structure indented into the second optical face. Furthermore, the second micro structure has a plurality of light guide portions interlacedly installed to each other. The thickness of the light guide portions are all equal or not equal, the intervals of any two spatially adjacent light guide portions are all equal or not equal or the light guide portions are spatially arranged to each other in equal or unequal proportions, and the heights of any two spatially adjacent light guide portions are not equal.

In a seventh preferred embodiment, the first micro structure is formed on the first optical face and has at least a light diffusion and collection portion for providing diffusing and collecting light, and the second micro structure is formed on the second optical face and has at least a light guide portion composed of an inclined face and a curved face.

The back light unit of the present invention can use any one of the aforementioned light guide plates. In a common preferred embodiment, the back light unit further includes an optical modulator installed on the light guide plate, at least a light emitting component installed around the light guide plate, and a light reflection piece installed under the light guide plate. Meanwhile, the back light unit further includes a protective film or an optical film formed on the optical modulator.

Compared with the prior art, the light guide plate which provides functions of light diffusion and light collection has a capability to regulate exit light distribution and exit light intensity by use of optical designability and controllability of the first and second micro structure according to the present invention. Meanwhile, the first micro structure has a tunable composite optical effect with light collection and diffusion functions so as to increase brightness and evenness of the exit light, and the second micro structure has a design of curved face for destroying total reflection of light, such that bright lines can be effectively prevented from occurrence by avoiding light outputting from the direction over against the first optical face. Therefore, the problems of the prior art can be solved.

### BRIEF DESCRIPTIONS OF DRAWINGS

The invention can be more fully understood by reading the following detailed description of the preferred embodiments, with reference made to the accompanying drawings, wherein:

FIG. 1A and FIG. 1B (PRIOR ART) are cross-sectional views showing two light guide plates disclosed in U.S. Pat. No. 6,568,822 B2;

FIG. 2 (PRIOR ART) is a cross-sectional view showing a light guide plate disclosed in U.S. Pat. No. 6,139,163;

FIG. 3A is a sectional view showing a structure of a light guide plate according to a first embodiment of the present invention;

FIG. 3B is a top view showing the light guide plate in FIG. 3A;

FIG. 4A to FIG. 4D are sectional views showing various examples of light diffusion portions and light collection portions of the light guide plate in FIG. 3A;

FIG. 5A is a cross-sectional view showing a light collection character of the light collection portion according to Snell's Law;

FIG. 5B is a cross-sectional view showing a diffusion character of the light diffusion portion according to lens characters;

FIG. 6 is a sectional view showing a light guide portion in FIG. 3A;

FIG. 7 is a side sectional view showing a back light unit using the light guide plate according to the first embodiment of the present invention;

FIG. 8A and FIG. 8B are side sectional views showing various examples of the back light unit in FIG. 7;

FIG. 9 is a sectional view showing a structure of a light guide plate according to a second embodiment of the present invention;

FIG. 10 is a sectional view showing a structure of a light guide plate according to a third embodiment of the present invention;

FIG. 11 is a sectional view showing a structure of a light guide plate according to a fourth embodiment of the present invention;

FIG. 12 is a sectional view showing a structure of a light guide plate according to a fifth embodiment of the present invention;

FIG. 13 is a sectional view showing a structure of a light guide plate according to a sixth embodiment of the present invention; and

FIG. 14A and FIG. 14B are amplified sectional views showing structures of arc-shaped faces and inverted V-shaped faces.

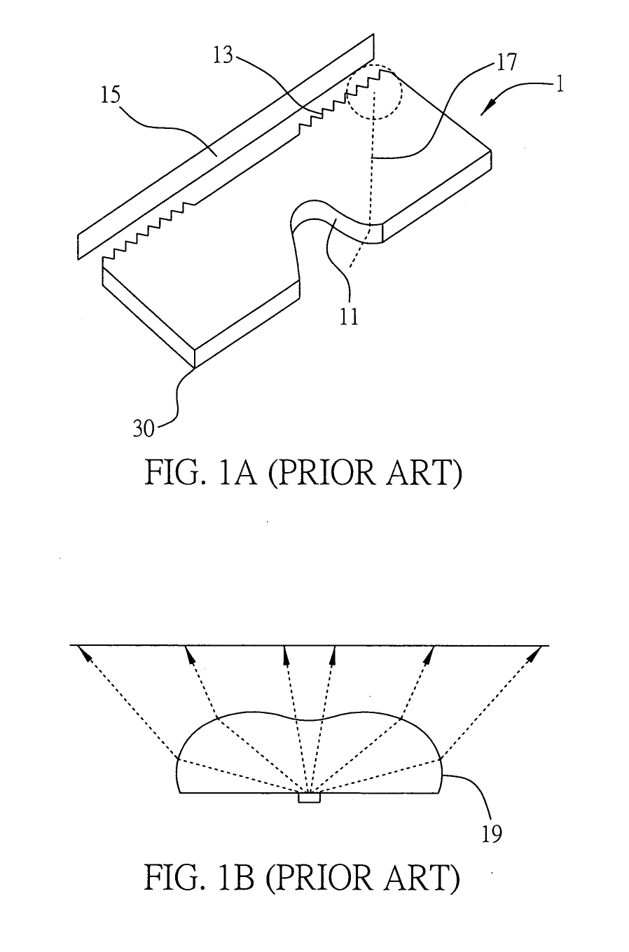

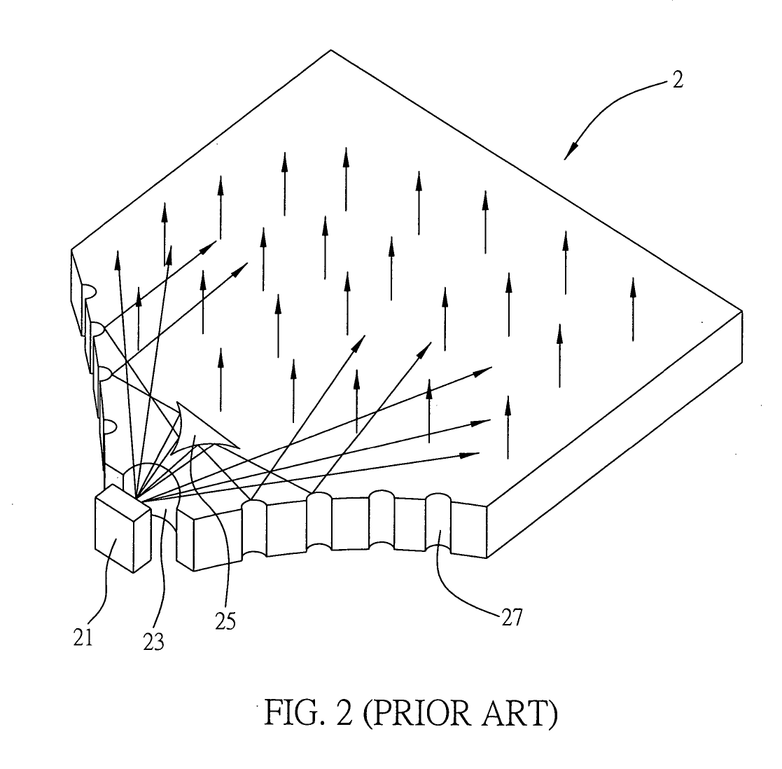

### DETAILED DESCRIPTIONS OF PREFERRED EMBODIMENTS

The following special embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

Furthermore, it should be noted that the appendant drawings are made in simplicity only to easily illustrate the basic structure of the present invention. Accordingly, only associated components of the present invention are shown in the drawings and these components are not drawn in actual numbers, shapes and dimensions, thereby the sizes of the components in practical implements may be an alternative design and the layout of the components may be more complicated.

### First Embodiment

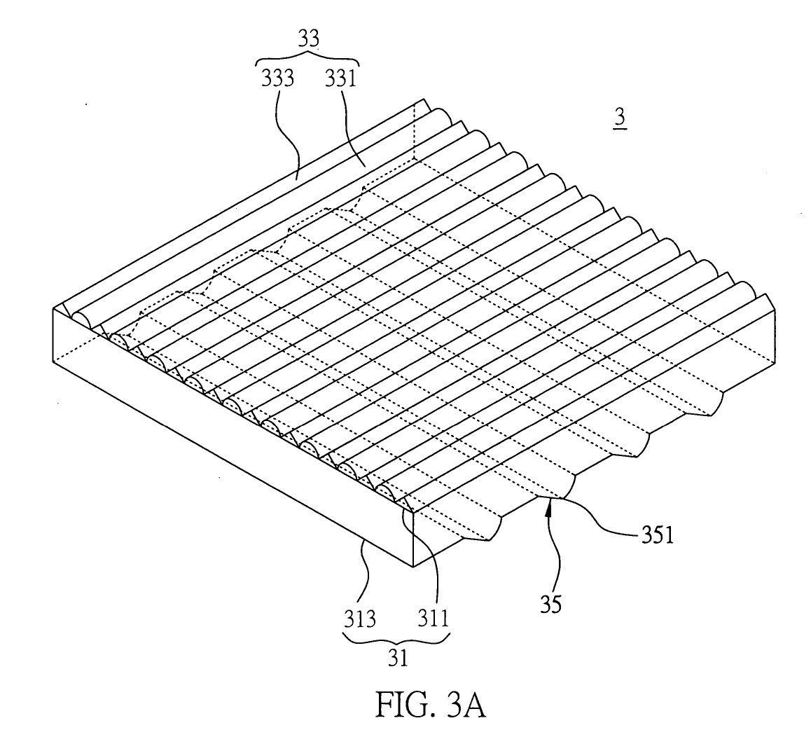

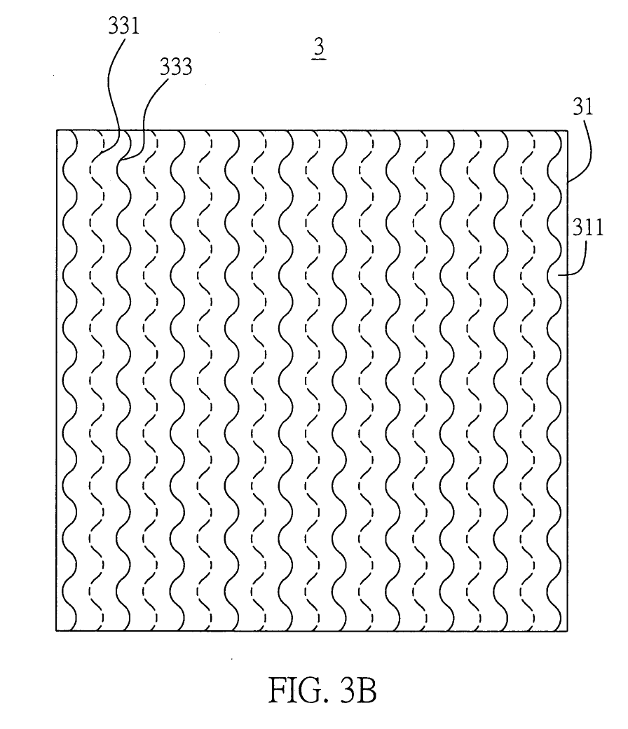

FIG. 3A to FIG. 8B are views showing a structure of a light guide plate 3 and a back light unit having the light guide plate of a first embodiment according to the present invention.

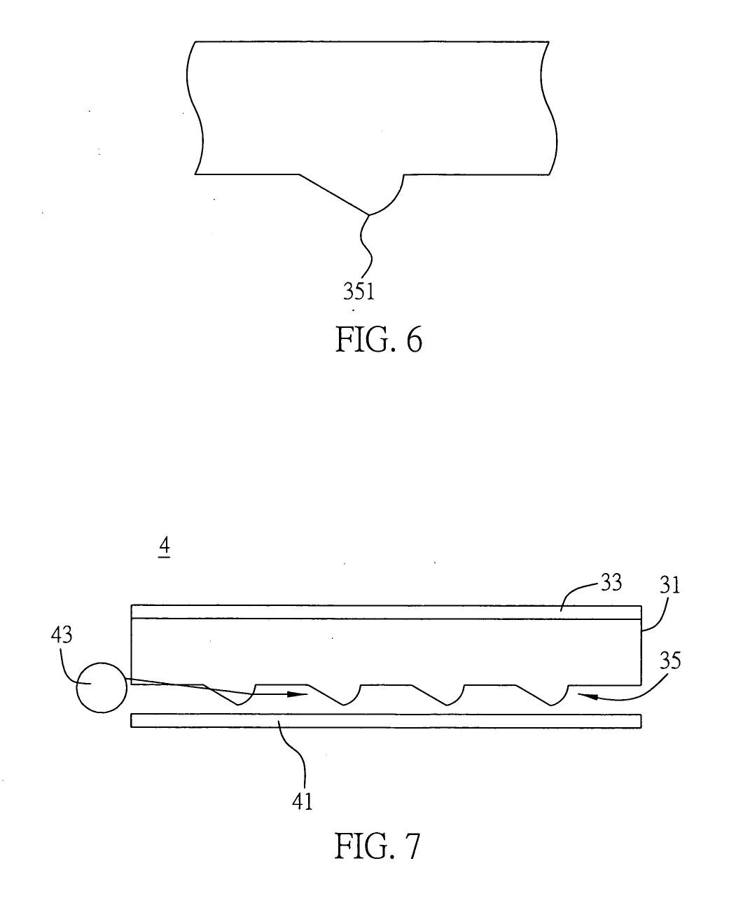

Please refer to FIG. 3A, which is a sectional view showing the light guide plate 3 of the present embodiment. The light guide plate 3 comprises a transparent substrate 31, a first micro structure 33 and a second micro structure 35 (shown in FIG. 7).

As shown in FIG. 3A, the transparent substrate 31 has a first optical face 311 and a second optical face 313 opposed to the first optical face 311. In this embodiment, the transparent substrate 31 is a transparent substrate and the like.

The first micro structure 33 is formed on the first optical face 311 and is made of transparent material. The first micro structure 33 comprises a plurality of light diffusion portions 331 installed in parallel to each other for diffusing light (exit light), and a plurality of light collection portions 333 installed in parallel to each other for collecting light (exit light). Each of the light diffusion portions 331 has an arc-shaped face, such as a spheric surface and an aspheric surface. A curvature radius of the arc-shaped face preferably ranges between 1 μm and 500 μm. Each of the light collection portions has an inverted V-shaped face, and a vertex angle of the inverted V-shaped face preferably ranges between 30 degrees and 140 degrees. It should be noted that a proportion between light collection intensity and diffusion intensity in accordance with different product demands can be regulated by properly selecting the curvature radii of the arc-shaped face of the light diffusion portions 331, the vertex angles of the inverted V-shaped face of the light collection portions 333, the height of the light diffusion portions 331 and the light collection portions 333, and material for the first micro structure 33 (for example, a refractive index). As these can be easily understood and modified by those in the art, they are not repeated herein.

Please refer to FIG. 3B, which is a top view showing the light guide plate 3 in FIG. 3A. As shown in the FIG. 3, the light diffusion portions 331 and light collection portions 333 are curvedly extended along a direction parallel to the first optical face 311; i.e. the light diffusion portions 331 and the light collection portions 333 are parallel to each other and bent with curved extensions.

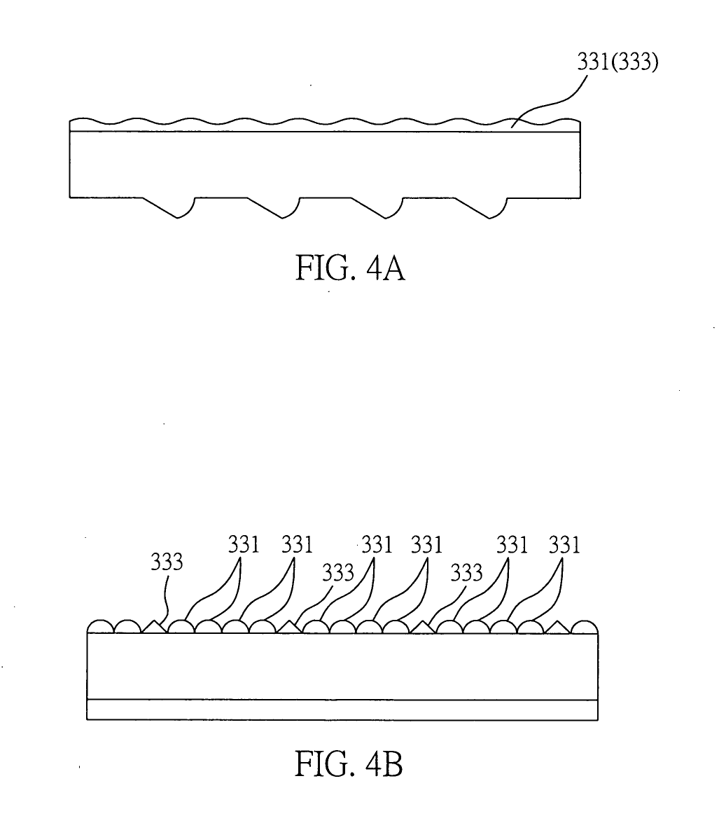

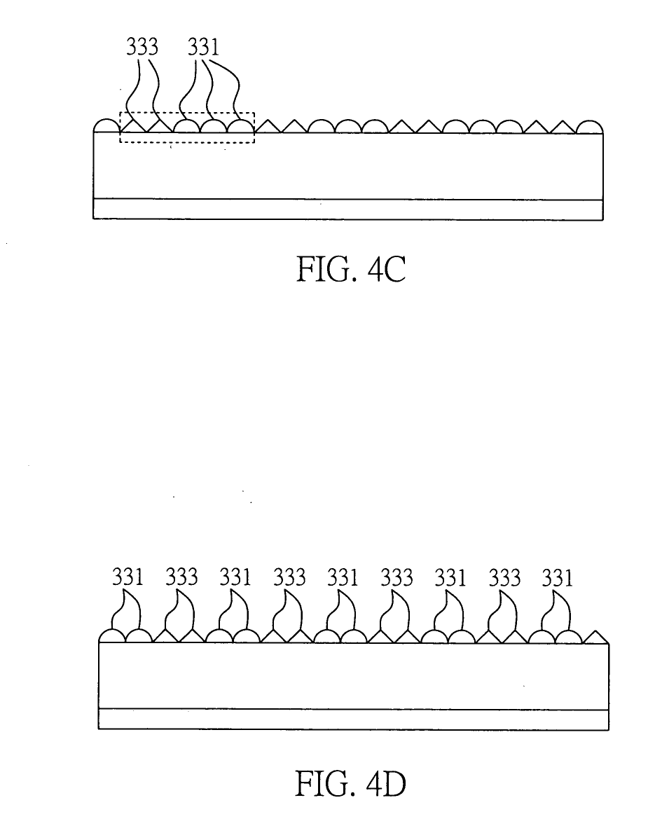

Certainly, the direction along which the light diffusion portions 331 and the light collection portions 333 are curvedly extended is designed to be perpendicular to the first optical face 311 in another embodiment (i.e. as shown in FIG. 4A, the heights of the light diffusion portions 331 and the light collection portions 333 are distributed as curved lines), or the light diffusion portions 331 and light collection portions 333 are linearly extended. Meanwhile, the light diffusion portions 331 and the light collection portions 333 are interlacedly in parallel to each other in equal proportions in this embodiment. As shown in FIG. 4B and FIG. 4C, the light diffusion portions 331 and the light collection portions 333 are interlacedly in parallel to each other in unequal proportions instead. A space number between the light diffusion portions 331 and the light collection portions 333 interlacedly in parallel to each other in equal proportions is not limited to one. For example, the space number may be two as shown in FIG. 4D, and three, four or more variations can be selected.

Please refer to FIG. SA. According to Snell's Law, the light collection portion 333 has good light collected performance for reducing a divergent angle of a light source. When entering a prism 7, an incident light 5 will be totally reflected from the prism 7 as a solid line arrow shown if an incident angle θ is larger than a critical angle of total reflection, or will pass through from the prism 7 as a dashed line arrow and then leave a normal line (the dashed line, the incident light 5 will leave a surface of the prism 7), thereby light collection effect can be attained.

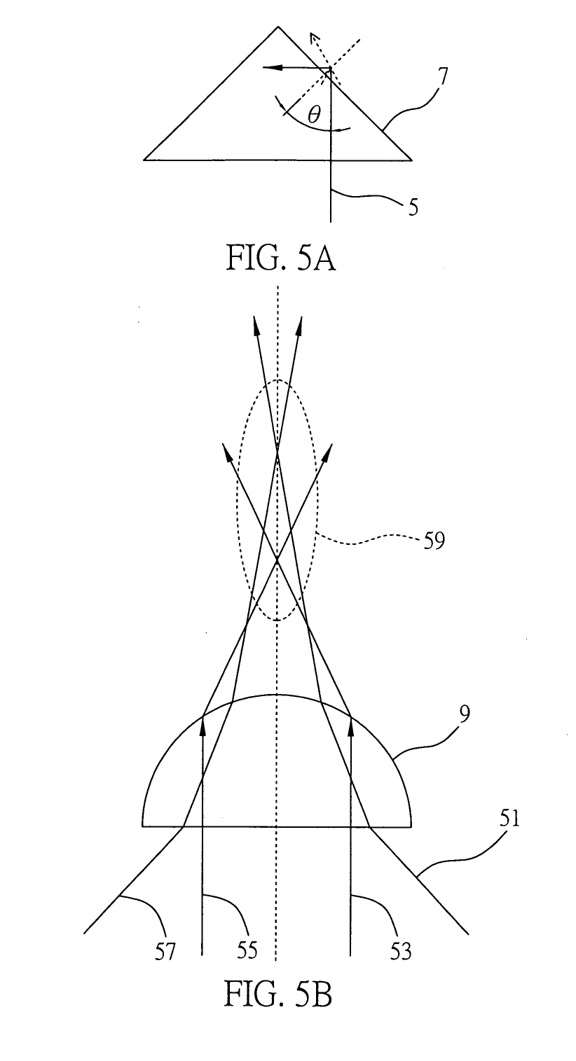

Referring to FIG. 5B, in optics, the light diffusion portion 331 has lens character because of its arc-shaped face, so it has a diffusion performance in an effective range. As shown in FIG. 5B, after entering a lens 9, abaxial incident light 51, 53, 55 and 57 are converged to a convergent area 59 first and then leave from the convergent area 59. Accordingly, an exit light angle of the light having a large incident angle will be converged and uniformed (or fuzzified) by use of various aberration characters caused by the lens converging the abaxial light.

As a result, the first micro structure 33 has composite effects with light diffusion and light collection. The light diffusion portion 331 having an aberration character of lens can fuzzify (or uniform) the incident light, and the light collection portion 333 can control the exit light angle of the incident light (the range of the exit light angle is related to the vertex angle of the inverted V-shaped face), such that dual effects of light collection and light diffusion can be provided.

The second micro structure 35 is formed on the second optical face 313. As shown in FIG. 6, the second micro structure 35 comprises at least a light guide portion 351 composed of an inclined face and a curved face. In this embodiment, the second micro structure 35 has a plurality of light guide portions 351 interlacedly installed to each other. The light guide portions 351 are projected from the second optical face 313, and the thickness of the light guide portions 351 are not equal. However, in other embodiments, the light guide portions 351 are indented into the second optical face 313, the thickness of the light guide portions 351 are not equal, and the intervals of any two spatially adjacent light guide portions are all equal or not equal.

Furthermore, the light guide plate 3 is made by a super-precision processing technology which has advantages in practical batch production. For example, a shaped monocrystal diamond pencil is processed on a metal mould in conjunction with UV curing by rolling and forming technology so that the micro structure on the mould can be formed onto an optical substrate. However the formation technology is not limited thereto, the processing principle and technology are not repeated herein as they have been understood to those in the art.

Please refer to FIG. 7. A back light unit 4 using the above-mentioned light guide plate 3 is provided in the present invention. The back light unit 4 comprises the light guide plate 3, a light reflection piece 41 installed under the light guide plate 3, and at least a light emitting component 43 installed around the light guide plate 3. The structure and principle of the back light unit is a prior art, further description hereby omitted.

Compared to the prior art, the second micro structure 35, which is formed on a bottom face of the light guide plate 3 of the present invention, is capable of preventing a total reflection from being happened on the curved face of the light guide portion 351, so as to overcome a drawback of the prior are that light exit from and form line light on a top area of the light guide portion 351. Therefore, light exited from the light guide potion 351 of the present invention is evenly distributed on the light guide plate 3. Therefore, the problem of bright lines in the prior art can be solved and the evenness of the light guide plate 3 can be enhanced.

Two different geometrical micro structures are designed on an optical material with high transparence in order to form a light guide plate having composite functions. The light guide plate, which is capable of diffusing and collecting light (providing diffusion and collection functions), is highly controllable and can take place of both conventional light collection piece and conventional diffusion piece for providing brightness and evenness effect. Moreover, such the curved and parallel design of the micro structure can avoid morie problems, and the micro structure of the light guide plate can be used in a back light unit to increase light efficiency, simplify the structure and reduce the cost.

Accordingly, the light guide plate and the back light unit having the light guide plate which have a tunable composite optical effect with light collection and diffusion functions can not only solve the problem of bright lines, but also solve the morie problems of the prior art.

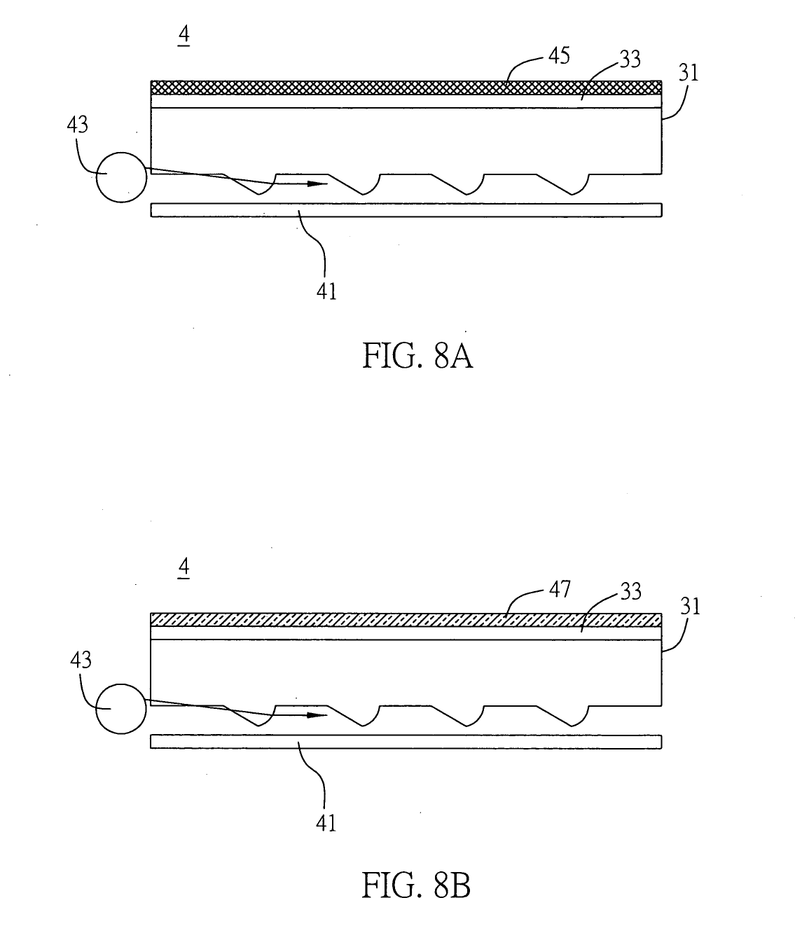

Meanwhile, the back light unit having the light guide plate 3 in the present invention can be used in combination with an optical film. For example, as shown in FIG. 8A, a protective film 45 is coated on the first micro structure 33 of the light guide plate 3, or as shown in FIG. 8B, an optical film 47 is coated thereon. Accordingly, the brightness and evenness of the exit light of the back light unit 3 is increased more, and the first micro structure 33 can be protected from scratch by the films 45, 47.

### Second Embodiment

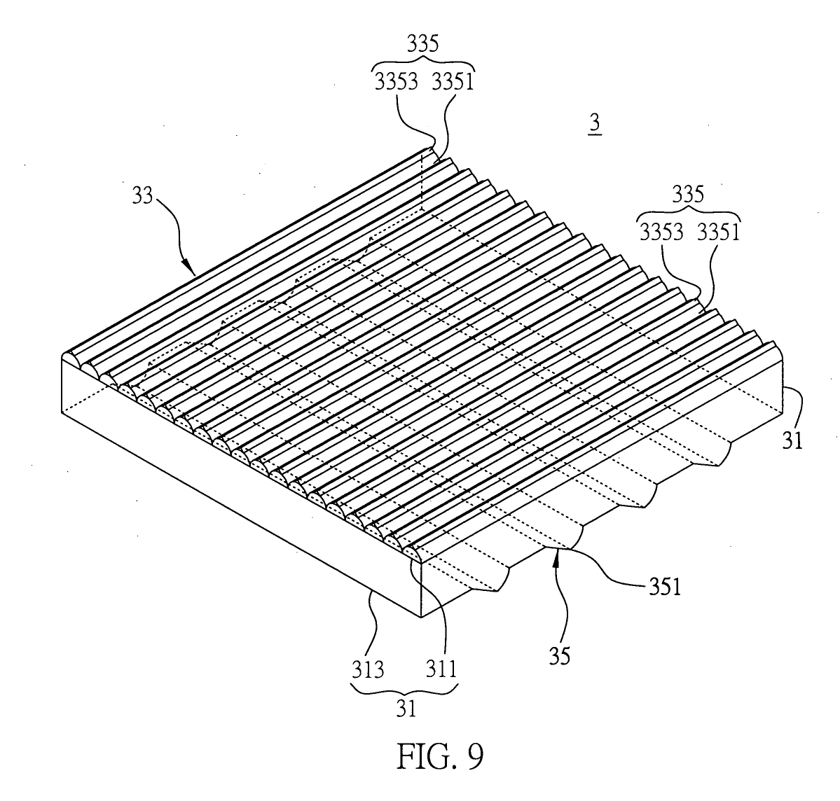

FIG. 9 is a sectional view showing a light guide plate and a back light unit having the light guide plate according to a second embodiment of the present invention. The components which are the same as or similar to those of the first embodiment are represented by the same or similar reference numbers and the detailed descriptions of these components are omitted in order to make the disclosure of the present invention easier to be understood.

The difference of the light guide plate between the second embodiment and the first embodiment is that, the first micro structure of the second embodiment has at least a light diffusion and collection composite portion, in instead of the light diffusion portions and the light collection portions, which are comprised in the light guide plate of the first embodiment.

As shown in FIG. 9, the light guide plate 3 comprises a transparent substrate 31, a first micro structure 33 and a second micro structure 35. The structure of the transparent substrate 31 and the second micro structure 35 can be the same as that of the first embodiment. The first micro structure 33 is also formed on the first optical face 311 and has at least a light diffusion and collection composite portion 335 for providing functions of light diffusion and light collection.

In the second embodiment, the first micro structure 33 has a plurality of curvedly extended light diffusion and collection composite portions 335 parallel to each other. Each of the light diffusion and collection composite portions 335 has an arc-shaped face 3351 and an inverted V-shaped face 3353 formed on the arc-shaped face 3351. The curvature radius of the arc-shaped face 3351 preferably ranges between 1 μm and 500 μm, and the vertex angle of the inverted V-shaped face 3353 preferably ranges between 30 degrees and 140 degrees. However, they are not limited thereto.

Certainly, the parallel light diffusion and collection composite portions 335 are curvedly extended with constant bend mentioned in the above embodiment, and the light diffusion and collection composite portion is curvedly extended along a direction parallel and/or perpendicular to the first optical face 311. Meanwhile, the proportion between light collection intensity and diffusion intensity of the first micro structure 33 in accordance with different product demands can be regulated by properly selecting the curvature radii of the arc-shaped face 3351, the vertex angles of the inverted V-shaped face 3353, the height of the arc-shaped face 3351 and the inverted V-shaped face 3353, and a refractive index of the first micro structure 33.

### Third Embodiment

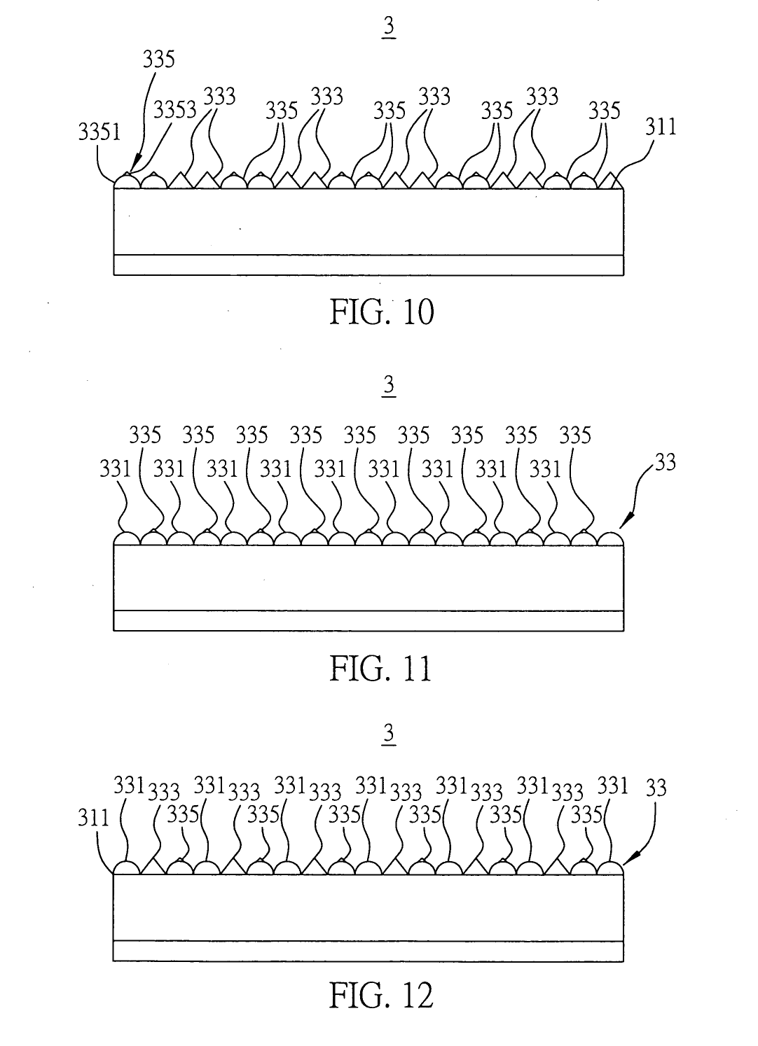

FIG. 10 is a sectional view showing a light guide plate and a back light unit having the light guide plate according to a third embodiment of the present invention. The components which are the same as or similar to those of the above embodiment are represented by the same or similar reference numbers and the detailed descriptions of these components are omitted.

The difference between the third embodiment and the above embodiment is that the first micro structure has a plurality of light diffusion and collection composite portions and light collection portions parallel to each other.

Referring to FIG. 10, the first micro structure 33 of the light guide plate 3 comprises a plurality of light diffusion and collection composite portions 335 and light collection portions 333 parallel to each other for providing functions of light diffusion and light collection. As described in the above embodiment, each of the light diffusion and collection composite portions 335 has an arc-shaped face 3351 and an inverted V-shaped face 3353 formed on the arc-shaped face 3351. The curvature radius of the arc-shaped face 3351 preferably ranges between 1 μm and 500 μm, and the vertex angle of the inverted V-shaped face 3353 preferably ranges between 30 degrees and 140 degrees. Each of, the light collection portions has an inverted V-shaped face 3353. The vertex angle of the inverted V-shaped face 3353 preferably ranges between 30 degrees and 140 degrees.

It should be understood, the light diffusion and collection composite portions 335 and the light collection portions 333 are interlacedly installed in parallel to each other in equal proportions in this embodiment, but they may also be interlacedly installed in parallel to each other in unequal proportions in other embodiments. Meanwhile, the light diffusion and collection composite portions 335 and light collection portions 333 are parallel to each other with curved extensions, and the curved extensions of the light diffusion and collection composite portion 335 and the light collection portion 333 are curvedly extended along a direction in parallel and/or perpendicular to the first optical face 311. Moreover, the parallel light diffusion and collection composite portions 335 and light collection portions 333 can be curvedly extended with constant bend. Furthermore, the space number between the light diffusion and collection composite portions 335 and the light collection portions 333 spatially parallel to each other in equal proportions is not limited to two in this embodiment.

### Fourth Embodiment

FIG. 11 is a sectional view showing a light guide plate and a back light unit having the light guide plate according to a fourth embodiment of the present invention. The components which are the same as or similar to those of the above embodiment are represented by the same or similar reference numbers and the detailed descriptions of these components are omitted.

The difference between the fourth embodiment and the third embodiment is that the first micro structure has a plurality of light diffusion and collection composite portions and light diffusion portions parallel to each other.

Referring to FIG. 11, the first micro structure 33 of the light guide plate 3 comprises a plurality of light diffusion and collection composite portions 335 and light diffusion portions 331 parallel to each other in equal proportions with one light diffusion portion 331 spaced to one diffused and light collection composite portion 335, but it is not limited thereto.

### Fifth Embodiment

FIG. 12 is a sectional view showing a light guide plate and a back light unit having the light guide plate according to a fifth embodiment of the present invention. The components which are the same as or similar to those of the above embodiment are represented by the same or similar reference numbers and the detailed descriptions of these components are omitted.

The difference between the fifth embodiment and the above embodiment is that the first micro structure comprises a plurality of light diffusion portions, light collection portions and light diffusion and collection composite portions, all of which are installed in parallel to each other.

Referring to FIG. 12, the first micro structure 33 of the light guide plate 3 comprises a plurality of light diffusion portions 331, light collection portions 333 and light diffusion and collection composite portions 335 for providing functions of light diffusion and light collection. In this embodiment, the light diffusion portions 331, the light collection portions 333 and the light diffusion and collection composite portions 335 are interlacedly installed in parallel to each other in equal proportions. The structures of these components are the same as the above embodiments, so they are not repeated herein.

Certainly, the light diffusion portions 331, the light collection portions 333 and the light diffusion and collection composite portions 335 are installed interlacedly to each other with curved extensions, and the curved extensions are curvedly extended along a direction parallel and/or perpendicular to the first optical face 311. Moreover, the light diffusion portions 331, the light collection portions 333 and the light diffusion and collection composite portions 335 can be curved extensions with constant bend. However, they are not limited thereto.

### Sixth Embodiment

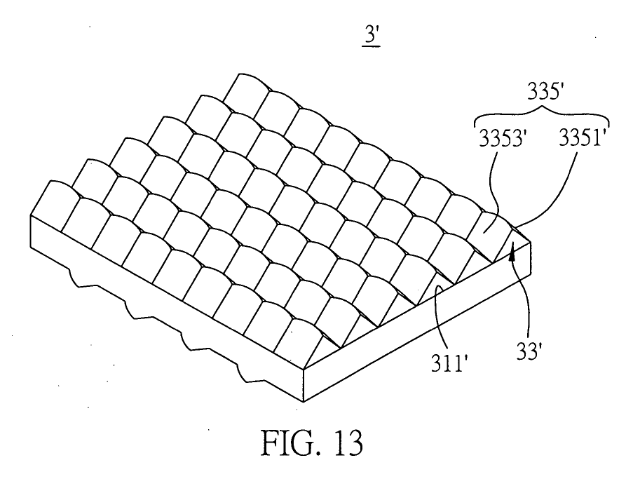

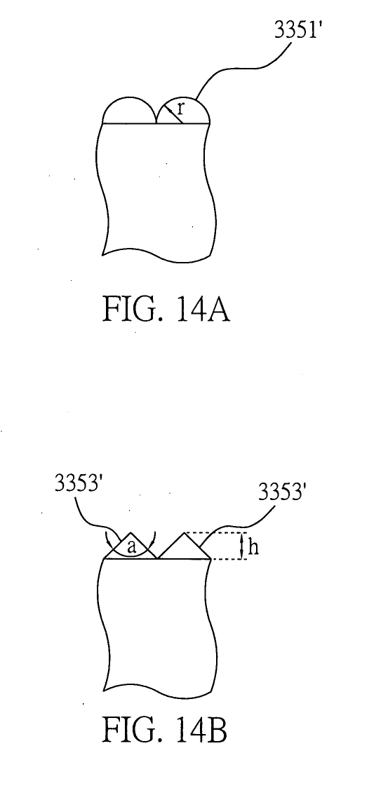

FIG. 13 to FIG. 14B are sectional views showing a light guide plate and a back light unit having the light guide plate according to a sixth embodiment of the present invention. The components which are the same as or similar to those of the above embodiment are represented by the same or similar reference numbers and the detailed descriptions of these components are omitted.

The difference between the sixth embodiment and the above embodiment is that the first micro structure comprises at least a light diffusion and collection composite portion. A first side of the light diffusion and collection composite portion has an arc-shaped face, and a second side adjacent to the arc-shaped face has an inverted V-shaped face.

Referring to FIG. 13, the first micro structure 33′ of the light guide plate 3′ comprises at least a light diffusion and collection composite portion 335′ for providing functions of light diffusion and light collection. A first side of the light diffusion and collection composite portion 335′ has an arc-shaped face 3351′, and a second side adjacent to the arc-shaped face 3351′ has an inverted V-shaped face 3353′.

As shown in FIG. 13, the first micro structure 33′ comprises a plurality of light diffusion and collection composite portions 335′ arranged in an array. The arc-shaped face 3351′ and the inverted V-shaped face 3353′ are perpendicular to each other. Meanwhile, at least one parallel direction of the light diffusion and collection composite portions 335′ arranged in an array has a curved extension, and the curved extension of the light diffusion and collection composite portion 335′ is curvedly extended along a direction parallel and/or perpendicular to the first optical face 311′.

As shown in FIG. 14A, a curvature radius r of the arc-shaped face 3351′ ranges between 1 μm and 500 μm. As shown in FIG. 14B, a vertex angle a of the inverted V-shaped face 3353′ ranges between 30 degrees and 140 degrees. The inverted V-shaped face 3353′ further comprises a vertical height h.

Accordingly, the proportion between light collection intensity and diffusion intensity of the light guide plate and the back light unit in accordance with different product demands can be regulated by properly selecting the vertex angle a, the curvature radius r, the vertical height h, the material for the light guide plate 3′ (the refractive index) and the space number of the light diffusion and collection composite portions 335′.

Certainly, variations of the light guide plate in accordance with different demands can be provided besides the above-mentioned embodiments according to the present invention. For example, the first micro structure 33′ of the sixth embodiment may have a smaller angle and a larger curvature radius. Meanwhile, the back light unit may include two interlaced and serried light guide plates, wherein the light guide plates may be one or two types mentioned in the above embodiments.

Furthermore, variations can be replaced between the above embodiments. For example, the light diffusion portion 331 and the light collection portion 333 from the first embodiment to the fourth embodiment may have a curved extension parallel to the first optical face and a curved extension perpendicular to the first optical face. It should be understood to those in the art that more than two interlaced and serried light guide plates can be selected to be formed on the back light unit.

The light guide plate of the present invention comprises a transparent substrate having a first optical face and a second optical face; a first micro structure and a second micro structure respectively corresponding to the first optical face and the second optical face, wherein the first micro structure has a tunable composite optical effect with light collection and diffusion functions so as to increase brightness and evenness of exit light; and the second micro structure has a design of curved face for destroying total reflection of light, such that bright lines can be effectively prevented from occurrence by avoiding light outputting from the direction over against the first optical face. Certainly, when the light guide plate of the present invention is used in a back light unit, the exit light brightness and evenness of the back light unit can be enhanced and bright lines can be avoided.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A light guide plate comprising:
a transparent substrate having a first optical face and a second optical face opposed to the first optical face;
a first micro structure formed on the first optical face, the first micro structure comprising:
one or more light diffusion portions for diffusing light; and
one or more light collection portions for collecting light, the light collection portions being disposed in parallel to the light diffusion portions; and
a second micro structure formed on the second optical face, the second micro structure comprising at least a light guide portion composed of an inclined face and a curved face.

2. The light guide plate of claim 1, wherein the light diffusion portions and the light collection portions are arranged interlacedly in parallel to each other in equal or unequal proportions.

3. The light guide plate of claim 1, wherein each of the light diffusion portions has an arc-shaped face and each of the light collection portions has an inverted V-shaped face.

4. The light guide plate of claim 3, wherein the arc-shaped face is one of a spheric surface and an aspheric surface.

5. The light guide plate of claim 3, wherein the arc-shaped face has a curvature radius ranged between 1 μm and 500 μm, and the inverted V-shaped face has a vertex angle ranged between 30 degrees and 140 degrees.

6. The light guide plate of claim 3, wherein the arc-shaped faces of any two adjacent light diffusion portions of the first micro structure have two unequal curvature radii, and the inverted V-shaped faces of any two adjacent light collection portions of the first micro structure have two unequal vertex angles.

7. The light guide plate of claim 1, wherein the light diffusion portions and the light collection portions of the first micro structure are linearly or curvedly extended light diffusion portions and light collection portions.

8. The light guide plate of claim 7, wherein the light diffusion portions and the light collection portions are curvedly extended along one of a first direction parallel to the first optical face and a second direction perpendicular to the first optical face.

9. The light guide plate of claim 1, wherein the light guide portion of the second micro structure has one of a projecting structure projected from the second optical face and an indented structure indented into the second optical face.

10. The light guide plate of claim 1, wherein the second micro structure comprises a plurality of light guide portions arranged in parallel to each other in equal or unequal proportions.

11. The light guide plate of claim 10, wherein any two adjacent light guide portions of the second micro structure are not equal in height.

12. A back light unit using the light guide plate of claim 1.

13. The back light unit of claim 12, further comprising:
an optical modulator installed on the light guide plate;
at least a light emitting component installed around the light guide plate; and
a light reflection piece installed under the light guide plate.

14. A light guide plate comprising:
a transparent substrate having a first optical face and a second optical face opposed to the first optical face;
a first micro structure formed on the first optical face, the first micro structure comprising one or more light diffusion and collection composite portions for diffusing and collecting light; and
a second micro structure formed on the second optical face, the second micro structure comprising at least a light guide portion composed of an inclined face and a curved face.

15. The light guide plate of claim 14, wherein the light diffusion and collection composite portions are arranged in parallel to each other in equal or unequal proportions.

16. The light guide plate of claim 14, wherein each of the light diffusion and collection composite portions has an arc-shaped face and an inverted V-shaped face formed on top of the arc-shaped face.

17. The light guide plate of claim 16, wherein the arc-shaped face is one of a spheric surface and an aspheric surface.

18. The light guide plate of claim 16, wherein the arc-shaped face has a curvature radius ranged between 1 μm and 500 μm, and the inverted V-shaped face has a vertex angle ranged between 30 degrees and 140 degrees.

19. The light guide plate of claim 16, wherein the arc-shaped faces of any two adjacent light diffusion and collection composite portions of the first micro structure have two unequal curvature radii, and the inverted V-shaped faces of any two adjacent light diffusion and collection composite portions of the first micro structure have two unequal vertex angles.

20. The light guide plate of claim 14, wherein the light diffusion and collection composite portions of the first micro structure are linearly or curvedly extended light diffusion and collection composite portions.

21. The light guide plate of claim 20, wherein the curvedly extended light diffusion and collection composite portions are curvedly extended along one of a first direction parallel to the first optical face and a second direction perpendicular to the first optical face.

22. The light guide plate of claim 14, wherein the light guide portion of the second micro structure has one of a projecting structure projected from the second optical face and an indented structure indented into the second optical face.

23. The light guide plate of claim 14, wherein the second micro structure comprises a plurality of light guide portions arranged in parallel to each other in equal or unequal proportions.

24. The light guide plate of claim 23, wherein any two adjacent light guide portions of the second micro structure are not equal in height.

25. A back light unit using the light guide plate of claim 14.

26. The back light unit of claim 25, further comprising:
an optical modulator installed on the light guide plate;
at least a light emitting component installed around the light guide plate; and
a light reflection piece installed under the light guide plate.

27. A light guide plate comprising:
a transparent substrate having a first optical face and a second optical face opposed to the first optical face;
a first micro structure formed on the first optical face, the first micro structure comprising:
one or more light diffusion and collection composite portions for diffusing and collecting light; and
one or more light collection portions for collecting light, the light collection portions being disposed in parallel to the light diffusion and collection composite portions; and
a second micro structure formed on the second optical face, the second micro structure comprising at least a light guide portion composed of an inclined face and a curved face.

28. The light guide plate of claim 27, wherein the light diffusion and collection composite portions and the light collection portions are arranged interlacedly in parallel to each other in equal or unequal proportions.

29. The light guide plate of claim 27, wherein each of the light diffusion and collection composite portions has an arc-shaped face and an inverted V-shaped face formed on top of the arc-shaped face, and each of the light collection portions has an inverted V-shaped face.

30. The light guide plate of claim 29, wherein the arc-shaped face is one of a spheric surface and an aspheric surface.

31. The light guide plate of claim 29, wherein the arc-shaped face has a curvature radius ranged between 1 μm and 500 μm, and the inverted V-shaped face has a vertex angle ranged between 30 degrees and 140 degrees.

32. The light guide plate of claim 29, wherein the arc-shaped faces of any two adjacent light diffusion and collection composite portions of the first micro structure have two unequal curvature radii, and the inverted V-shaped faces of any two adjacent light diffusion and collection composite portions or any two adjacent light collection portions of the first micro structure have two unequal vertex angles.

33. The light guide plate of claim 27, wherein the light diffusion and collection composite portions and the light collection portions of the first micro structure are linearly or curvedly extended light diffusion and collection composite portions and light collection portions.

34. The light guide plate of claim 33, wherein the curvedly extended light diffusion and collection composite portions and light collection portions are extended along one of a first direction in parallel to the first optical face and a second direction perpendicular to the first optical face.

35. The light guide plate of claim 27, wherein the light guide portion of the second micro structure has one of a projecting structure projected from the second optical face and an indented structure indented into the second optical face.

36. The light guide plate of claim 27, wherein the second micro structure comprises a plurality of light guide portions arranged in parallel to each other in equal or unequal proportions.

37. The light guide plate of claim 36, wherein any two adjacent light guide portions of the second micro structure are not equal in height.

38. A back light unit using the light guide plate of claim 27.

39. The back light unit of claim 38, further comprising:
an optical modulator installed on the light guide plate;
at least a light emitting component installed around the light guide plate; and
a light reflection piece installed under the light guide plate.

40. A light guide plate comprising:
a transparent substrate having a first optical face and a second optical face opposed to the first optical face;
a first micro structure formed on the first optical face, the first micro structure comprising:
one or more light diffusion and collection composite portions for diffusing and collecting light; and
one or more light diffusion portions for diffusing light, the light diffusion portions being disposed in parallel to the light diffusion and collection composite portions; and
a second micro structure formed on the second optical face, the second micro structure comprising at least a light guide portion composed of an inclined face and a curved face.

41. The light guide plate of claim 40, wherein the light diffusion and collection composite portions and the light diffusion portions are arranged interlacedly in parallel to each other in equal or unequal proportions.

42. The light guide plate of claim 40, wherein each of the light diffusion and collection composite portions has an arc-shaped face and an inverted V-shaped face formed on top of the arc-shaped face, and each of the light diffusion portions has an arc-shaped face.

43. The light guide plate of claim 42, wherein the arc-shaped face is one of a spheric surface and an aspheric surface.

44. The light guide plate of claim 42, wherein the arc-shaped face has a curvature radius ranged between 1 μm and 500 μm, and the inverted V-shaped face has a vertex angle ranged between 30 degrees and 140 degrees.

45. The light guide plate of claim 42, wherein the arc-shaped faces of any two adjacent light diffusion and collection composite portions or any two adjacent light diffusion portions of the first micro structure have two unequal curvature radii, and the inverted V-shaped faces of any two adjacent light diffusion and collection composite portions of the first micro structure have two unequal vertex angles.

46. The light guide plate of claim 40, wherein the light diffusion and collection composite portions and the light diffusion portions of the first micro structure are linearly or curvedly extended light diffusion and collection composite portions and light diffusion portions.

47. The light guide plate of claim 46, wherein the curvedly extended light diffusion and collection composite portions and light diffusion portions are curvedly extended along one of a first direction in parallel to the first optical face and a second direction perpendicular to the first optical face.

48. The light guide plate of claim 40, wherein the light guide portion of the second micro structure has one of a projecting structure projected from the second optical face and an indented structure indented into the second optical face.

49. The light guide plate of claim 40, wherein the second micro structure comprises a plurality of light guide portions arranged in parallel to each other in equal or unequal proportions.

50. The light guide plate of claim 49, wherein any two adjacent light guide portions of the second micro structure are not equal in height.

51. A back light unit using the light guide plate of claim 40.

52. The back light unit of claim 51, further comprising:
an optical modulator installed on the light guide plate;
at least a light emitting component installed around the light guide plate; and
a light reflection piece installed under the light guide plate.

53. A light guide plate comprising:
a transparent substrate having a first optical face and a second optical face opposed to the first optical face;
a first micro structure formed on the first optical face, the first micro structure comprising:
one or more light diffusion portions for diffusing light;
one or more light collection portions for collecting light; and
one or more light diffusion and collection composite portions for diffusing and collecting light, wherein the light diffusion portions, the light collection portions and the light diffusion and collection composite portions are arranged in parallel to each other; and
a second micro structure formed on the second optical face, the second micro structure comprising at least a light guide portion composed of an inclined face and a curved face.

54. The light guide plate of claim 53, wherein the light diffusion portions, the light collection portions and the light diffusion and collection composite portions are arranged interlacedly in parallel to each other in equal or unequal proportions.

55. The light guide plate of claim 53, wherein each of the light diffusion and collection composite portions comprises an arc-shaped face and an inverted V-shaped face formed on top of the arc-shaped face, each of the light diffusion portions comprises an arc-shaped face, and each of the light collection portions comprises an inverted V-shaped face.

56. The light guide plate of claim 55, wherein the arc-shaped face is one of a spheric surface and an aspheric surface.

57. The light guide plate of claim 55, wherein the arc-shaped face has a curvature radius ranged between 1 μm and 500 μm, and the inverted V-shaped face has a vertex angle ranged between 30 degrees and 140 degrees.

58. The light guide plate of claim 55, wherein the arc-shaped faces of any two adjacent light diffusion and collection composite portions or any two adjacent light diffusion portions of the first micro structure have two unequal curvature radii, and the inverted V-shaped faces of any two adjacent light diffusion and collection composite portions or any two adjacent light collection portions of the first micro structure have two unequal vertex angles.

59. The light guide plate of claim 53, wherein the light diffusion portions, the light collection portions and the light diffusion and collection composite portions of the first micro structure are linearly or curvedly extended light diffusion portions, light collection portions and light diffusion and collection composite portions.

60. The light guide plate of claim 59, wherein the curvedly extended light diffusion portions, light collection portions and light diffusion and collection composite portions are curvedly extended along one of a first direction in parallel to the first optical face and a second direction perpendicular to the first optical face.

61. The light guide plate of claim 53, wherein the light guide portion of the second micro structure has one of a projecting structure projected from the second optical face and an indented structure indented into the second optical face.

62. The light guide plate of claim 53, wherein the second micro structure comprises a plurality of light guide portions arranged in parallel to each other in equal or unequal proportions.

63. The light guide plate of claim 62, wherein any two adjacent light guide portions of the second micro structure are not equal in height.

64. A back light unit using the light guide plate of claim 53.

65. The back light unit of claim 64, further comprising:
an optical modulator installed on the light guide plate;
at least a light emitting component installed around the light guide plate; and
a light reflection piece installed under the light guide plate.

66. A light guide plate comprising:
a transparent substrate having a first optical face and a second optical face opposed to the first optical face;
a first micro structure formed on the first optical face, the first micro structure comprising one or more light diffusion and collection composite portions for diffusing and collecting light, each of the light diffusion and collection composite portions comprising:
a first side having an arc-shaped face; and
a second side adjacent to the first side, the second side having an inverted V-shaped face; and
a second micro structure formed on the second optical face, the second micro structure comprising at least a light guide portion composed of an inclined face and a curved face.

67. The light guide plate of claim 66, wherein the light diffusion and collection composite portions of the first micro structure are arranged in an array.

68. The light guide plate of claim 6, wherein the light diffusion and collection composite portions are arranged in an array, and at least a direction along which the light diffusion and collection composite portions are arranged is a curvedly extended direction.

69. The light guide plate of claim 68, wherein the curvedly extended direction is one of a first direction in parallel to the first optical face and a second direction perpendicular to the first optical face.

70. The light guide plate of claim 66, wherein the arc-shaped face and the inverted V-shaped face are perpendicular to each other.

71. The light guide plate of claim 66, wherein the arc-shaped face has a curvature radius ranged between 1 μm and 500 μm, and the inverted V-shaped face has a vertex angle ranged between 30 degrees and 140 degrees.

72. The light guide plate of claim 66, wherein the arc-shaped face is one of a spheric surface and an aspheric surface.

73. The light guide plate of claim 66, wherein the light guide portion of the second micro structure has one of a projecting structure projected from the second optical face and an indented structure indented into the second optical face.

74. The light guide plate of claim 66, wherein the second micro structure comprises a plurality of light guide portions arranged in parallel to each other in equal or unequal proportions.

75. The light guide plate of claim 74, wherein any two adjacent light guide portions of the second micro structure are not equal in height.

76. A back light unit using the light guide plate of claim 66.

77. The back light unit of claim 76, further comprising:
an optical modulator installed on the light guide plate;
at least a light emitting component installed around the light guide plate; and
a light reflection piece installed under the light guide plate.

78. A light guide plate comprising:
a transparent substrate having a first optical face and a second optical face opposed to the first optical face;
a first micro structure formed on the first optical face, the first micro structure comprising one or more light diffusion and collection portions for diffusing and collecting light; and
a second micro structure formed on the second optical face, the second micro structure comprising at least a light guide portion composed of an inclined face and a curved face.
